(19) United States
(12) Patent Application Publication
(10) Pub. No.: US 2010/0235235 A1
(43) Pub. Date: Sep. 16, 2010

(54) ENDORSABLE ENTITY PRESENTATION BASED UPON PARSED INSTANT MESSAGES

(75) Inventors: S. Farid Hosseini, Redmond, WA (US); Christopher Parker, Seattle, WA (US); Katherine Jones, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/400,989

(22) Filed: Mar. 10, 2009

(51) Int. Cl. G06Q 30/00; G06F 15/16; G06Q 99/00

(52) U.S. Cl. 705/14.49; 709/206; 705/1.1

(57) ABSTRACT

During an instant message conversation, instant message users may be presented with advertisements, news headlines, hyperlinks to web pages, and other additional information. It may be advantageous to provide targeted information that may be relevant to the current conversation between the instant message users. As provided herein, an endorsable entity may be presented to an instant message user based upon parsing an instant message from an instant message conversation. An instant message may be parsed for a proper noun (e.g., a word or grouping of words within the instant message text). The proper noun (e.g., a retail product) may be compared to an index to determine a topic of interest (e.g., a manufacturer of the particular retail product). The topic of interest may be used to determined an endorsable entity (e.g., an advertisement of the manufacturer), which may be presented to instant message users engaged in the instant message conversation.

### BACKGROUND

Many people communicate through Instant Message (IM) conversations. This allows users to communicate in real-time with other users through social networking websites, computing environments, cell phones, and/or other communication devices. An instant message user may be presented with additional information, such as advertisements, hyperlinks to websites, and/or news headlines, for example. Unfortunately, the additional information may be irrelevant to the IM user and/or their conversation. The IM user may thus be likely to ignore the additional information altogether.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A technique for presenting an endorsable entity based upon a parsed instant message is disclosed herein. An instant message (IM) may be parsed for a proper noun (e.g., a word or grouping of words within the IM). In one example, substring matching may be performed upon real-time data of an IM session to determine one or more proper nouns. A proper noun may be a specific name of a company, a product, etc. that an IM user is communicating about. The proper noun is compared to an index to determine a topic of interest. The index may comprise data correlating proper nouns and/or their variations (e.g., a variation of a “Silver Bullet Sports Car” proper noun may be a “SB Sports Car”) with topics of interest (e.g., a company that manufactures the Silver Bullet Sports Car, a car dealer that sells the Silver Bullet Sports Car, etc.). Among other things, the index may be a database, a hash, a table and/or a web service, for example. If a particular proper noun is parsed within multiple instant messages and is not present in the index, then an intelligent suggestion may be created to indicate that adding the proper noun to the index may be beneficial (e.g., since multiple IM users may be discussing it).

An endorsable entity may be presented to an IM user based upon the topic of interest. Among other things, the endorsable entity may comprise an advertisement, a hyperlink to a webpage, a user interface element (e.g., an image), and/or a subscription request corresponding to the topic of interest, for example. In one example, the endorsable entity may be determined by querying an endorsement engine (e.g., an advertisement engine) with the topic of interest. The endorsable entity may be presented to an IM sender and/or an IM recipient. Upon the IM user endorsing the endorsable entity (e.g., a user subscribes to a group corresponding to the manufacturer of the Silver Bullet Sports Car), a social network feed may be created, thus allowing other users (e.g., friends of the IM user) to be notified of the endorsement.

It may be appreciated that an instant message user may be prompted to consent to instant message parsing as provided herein (e.g., for the purpose of presenting endorsable entities). For example, a user may be prompted with a dialog box explaining that data (e.g., proper nouns) may be parsed from instant messages for the limited purpose of presenting endorsable entities, wherein the user may then consent (or not) to the parsing.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of presenting an endorsable entity based upon a parsed instant message.

FIG. 2 is a component block diagram illustrating an exemplary system for presenting an endorsable entity based upon a parsed instant message.

FIG. 3A is an illustration of an example of presenting an endorsable entity based upon a parsed instant message.

FIG. 3B is an illustration of an example of presenting an endorsable entity based upon a parsed instant message.

FIG. 4A is an illustration of an example of parsing one or more proper nouns from an instant message.

FIG. 4B is an illustration of an example of parsing one or more proper nouns from an instant message.

FIG. 4C is an illustration of an example of parsing one or more proper nouns from an instant message.

FIG. 5 is an illustration of an example of comparing a proper noun to an index to determine a topic of interest.

FIG. 6 is an illustration of an example of determining an endorsable entity based upon a topic of interest.

FIG. 7 is an illustration of an example of presenting an endorsable entity based upon a parsed instant message.

FIG. 8 is an illustration of an example of presenting an endorsable entity based upon a parsed instant message.

FIG. 9 is an illustration of an example of creating an intelligent suggestion based upon an instant message session.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Instant message (IM) users engaged in an instant message (IM) session may discuss various topics during their IM conversations. It may be advantageous to present the IM users with additional information pertaining to their IM conversations. Currently, additional information (e.g., an advertisement) presented to the IM users is typically irrelevant to the ongoing IM conversations. The IM users are thus likely to ignore the additional information.

Among other things, a technique for presenting an endorsable entity based upon a parsed instant message is provided herein. By mining an IM conversation for proper nouns, topics of interest being discussed may be identified. The topics of interest may be used to determine advertisements, subscription groups, web pages, and/or other content relevant to the IM conversation. This provides the IM users with a customized experience based upon real-time information from their IM conversation. For example, an IM user may be engaged in an IM conversation pertaining to a Silver Bullet Sports Car. Based upon identifying a proper noun (e.g., “Silver Bullet Sports Car”) from an IM and identifying a corresponding topic of interest, the user may be presented with additional information related to a subscription to a group pertaining to the Silver Bullet Sports Car. If the user joins the group, then other users (e.g., friends) may be notified through a feed item within a social network that their friend joined the Silver Bullet Sports Car group.

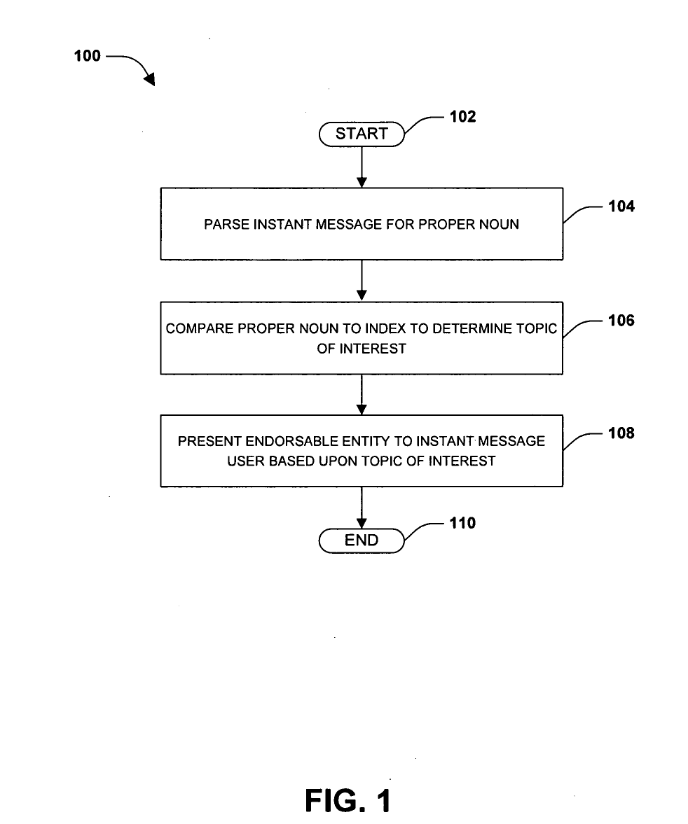

One embodiment of presenting an endorsable entity based upon a parsed instant message is illustrated by an exemplary method 100 in FIG. 1. At 102, the method begins. At 104, an instant message (IM) is parsed for a proper noun. For example, a service may monitor real-time content of instant messages within an IM session. The service may parse the IM using a substring matching technique, for example. It may be appreciated that one or more proper nouns may be parsed within the IM, wherein the one or more proper nouns may comprise one or more words (e.g., adjacent words within the IM) within the IM.

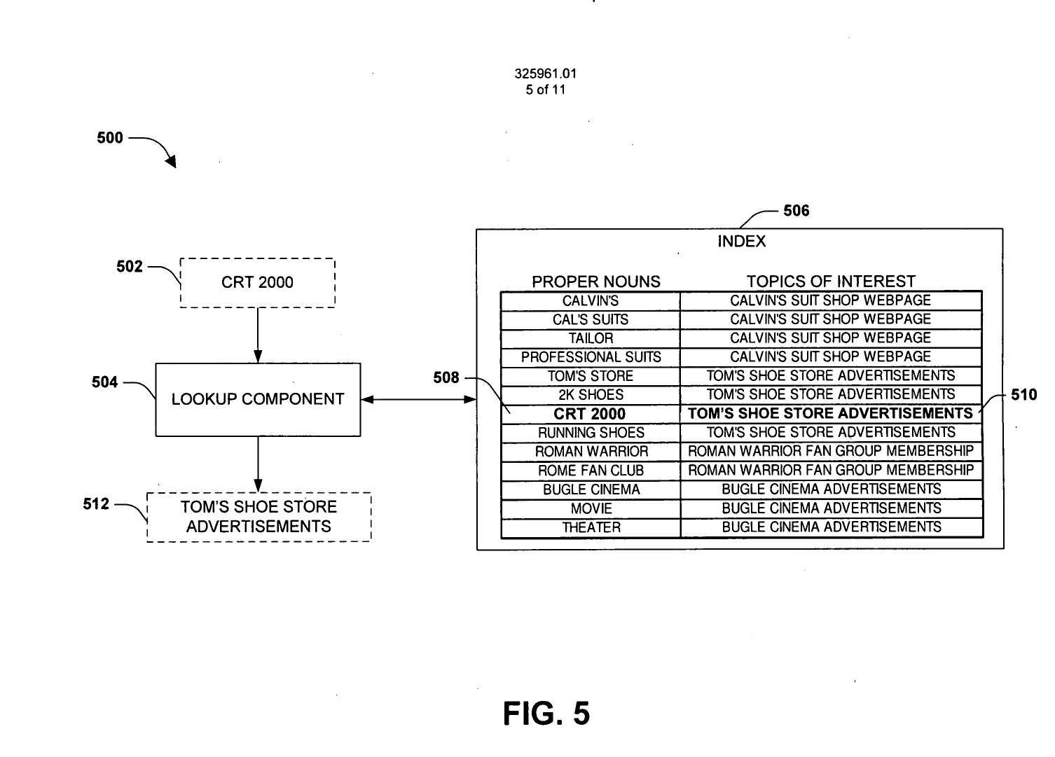

At 106, the proper noun may be compared to an index (e.g., an index 506 in FIG. 5) to determine a topic of interest. Because a user may use a variation of a proper noun (e.g., an expansion, contraction, abbreviation, nickname, and/or initials of the proper noun), the index may comprise variations of the proper noun. Among other things, the index may be a data table, a database, a hash, a web service, and/or other data structures correlating proper nouns with topics of interest, for example. The topic of interest may identify the general topic being discussed within the IM session (e.g., terms identifying cities, people, organizations, and/or businesses). For example, if a proper noun “Silver Bullet Sports Car” is parsed from an IM, then a topic of interest may be a manufacturer of the Silver Bullet Sports Car.

If a proper noun is parsed at a frequency exceeding a predetermined threshold (e.g., “Silver Bullet Sports Car” may be parsed in 5 instant messages within an IM session) and the proper noun is not within the index, then an intelligent suggestion may be created. In one example, the intelligent suggestion may provide information regarding the desirability of adding the proper noun to the index along with a corresponding topic of interest. This allows the index to be updated based upon IM conversations.

At 108, an endorsable entity may be presented to an IM user based upon the topic of interest. The endorsable entity may be presented to an IM sender and/or an IM recipient. For example, an endorsable entity may be encoded within IM metadata, which may be sent to an IM user for display and/or for updating an IM conversation history with a hyperlink corresponding to the endorsable entity. It may be appreciated that an instant message client running on an IM device may be configured to consume the IM metadata and transform the encoded endorsable entity into a presentable entity (e.g., a user interface) which may be displayed to the IM user. Among other things, the endorsable entity may comprise an advertisement, a hyperlink to a web page, a user interface element (e.g., an image), and/or a subscription request corresponding to the topic of interest, for example. In one example, the endorsable entity may be determined based upon querying an endorsement engine with the topic of interest. In response to the query, an advertisement corresponding to the topic of interest may be returned (e.g., an advertisement corresponding to a manufacturer of a car may be returned as an endorsable entity).

If a user endorses the endorsable entity (e.g., a user subscribes to a particular group corresponding to the topic of interest), then a feed time may be created within a social network. This may allow other users (e.g., friends) to be notified that the user has invoked the endorsable entity (e.g., subscribed to the group). At 110, the method ends.

It may be appreciated that the index may be created “offline” before an IM session takes place. In one example, the index may be formed based upon a list of terms in their canonical form (e.g., proper nouns). The list of terms may be expanded to comprise variations of the terms. The expanded list may be stored in the index configured with quick read access. During an instant message session, instant messages may be parsed when they are passing through an instant message service. To enhance performance, stop words (e.g., “the”, “and”, “but”, etc.) may be removed from an instant message because of the high probability the stop words are not in the index. It may be appreciated that stop words may be removed from entries within the index for, among other things, efficiency purposes (e.g., “Tom and Bob's ice cream” may be converted and stored as “Tom Bob's ice cream” in the index). Accordingly, parsing stop words from an instant message may provide little to no benefit since the index may not comprise stop words. That is, an exact match between a parsed proper noun and an entry within the index may not be found where the parsed proper noun comprises stop words, but the index does not. Permutations of remaining terms within the instant message may be determined and sent to a lookup service.

It may be appreciated that a parsed proper noun may comprise one or more words within the IM (e.g., a grouping of adjacent words within the IM) because the index may comprise terms (e.g., proper noun entries within the index) having multiple words. In one example, only adjacent words may be considered and a configurable threshold may be set as to the number of adjacent words that may be considered. The lookup service may return whether the parsed proper noun (e.g., a single term, a word grouping, etc.) matches a term within the index. If a match is determined, then a corresponding endorsable entity may be appended to IM metadata associated with the instant message, where such endorsable entity IM metadata may be provided back to both a sender and/or recipient of the IM. If no match is determined, then nothing may be done with the term. It may be appreciated that multiple proper nouns may be parsed within an IM and that one or more of the parsed proper nouns may or may not match terms within the index. It may be appreciated that a term within the index may be interpreted as a proper noun entry within the index having a corresponding topic of interest.

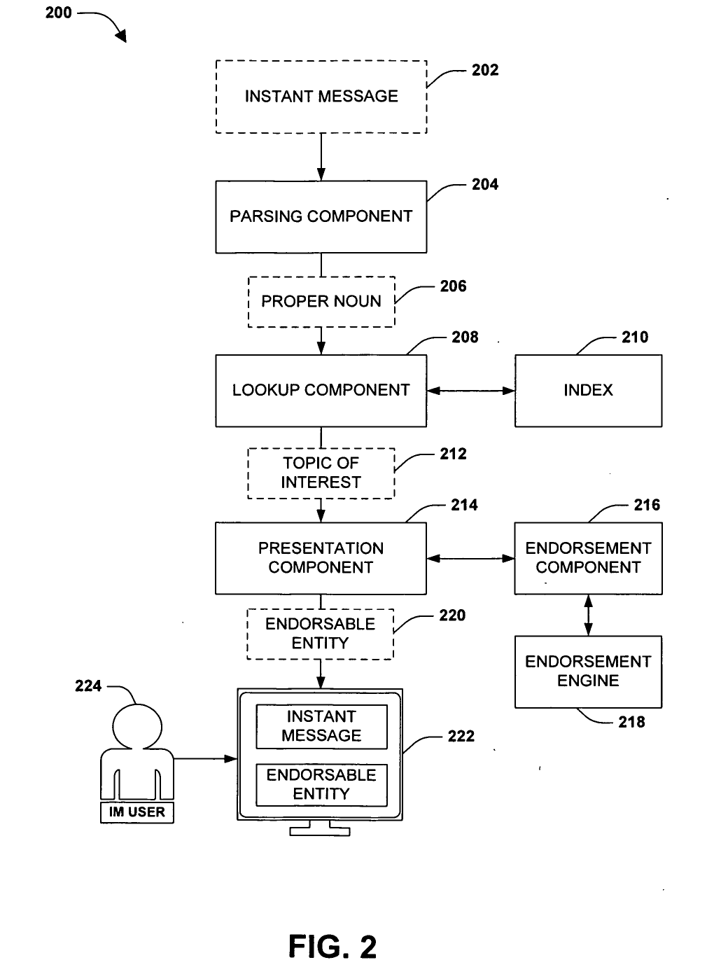

FIG. 2 illustrates an example 200 of a system configured for presenting an endorsable entity based upon a parsed instant message. The system may comprise a parsing component 204, a lookup component 208, and/or a presentation component 214. The system may further comprise an endorsement component 216. The parsing component 204 may be configured to parse an instant message 202 for a proper noun 206. The parsing component 204 may be configured to monitor real-time data of an instant message session between one or more users, wherein the instant message session comprising one or more instant messages (e.g., the instant message 202). It may be appreciated that a parsing component may extract a word or a grouping of words as proper nouns for lookup within an index.

The lookup component 208 may be configured to compare the proper noun 206 to an index 210 to determine a topic of interest 212. The index 210 may comprise a data structure (e.g., a data table, a database, a hash, etc.) that correlates proper nouns (e.g., a variety of consumer products) with topics of interest (e.g., a manufacturer of the consumer products). Because a proper noun may be referred to in a variety of ways (e.g., expansion, contraction, and/or acronym of the proper noun), variations of the proper noun 206 may comprised within the index 210. If a proper noun is parsed at a frequency exceeding a predetermined threshold (e.g., the proper noun is referred to in 5 instant messages within an instant message session) and the proper noun is not within the index 210, then an intelligent suggestion may be created to provide information regarding updating the index 210 with the proper noun.

The presentation component 214 may be configured to present (e.g., on some type of monitor 222) an endorsable entity 220 to an IM user 224 based upon the topic of interest 212. In one example, the endorsement component 216 may determine the endorsable entity 220 by querying an endorsement engine 218 with the topic of interest 212. For example, a cell phone manufacturer (e.g., a topic of interest) may be used to query the endorsement engine 218 to determine an advertisement (e.g., an endorsable entity) corresponding to the cell phone manufacturer. Among other things, the endorsable entity may comprise an advertisement, a hyperlink to a web page, a user interface element, and/or a subscription request, for example. The presentation component 214 may be configured to create a feed item within a social network based upon the IM user 224 invoking the endorsable entity 220. This may allow other users associated with the IM user 224 to learn of the IM user's interest in the endorsable entity 220.

In one example, the presentation component 214 may encode the endorsable entity 220 within instant message metadata. The instant message metadata may be delivered to an IM sender (e.g., an IM user originating the IM from which the endorsable entity 220 was derived), wherein the endorsable entity 220 may be presented to the IM sender (e.g., add a hyperlink corresponding to the endorsable entity 220 within a conversation history of an IM session). The IM metadata may also be delivered to an IM recipient (e.g., an IM user that received the IM from which the endorsable entity 220 was derived), wherein the endorsable entity 220 may be presented to the IM recipient.

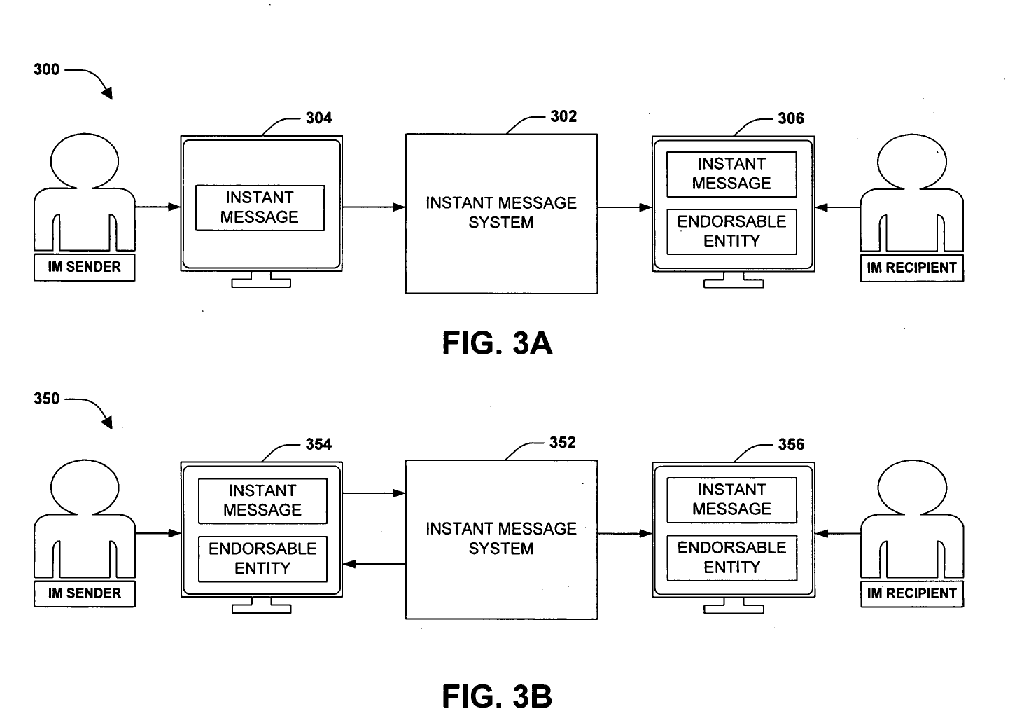

FIG. 3A illustrates an example 300 of presenting an endorsable entity based upon a parsed instant message. In example 300, an IM sender may create an instant message 304 intended for delivery to an IM recipient. An instant message system 302 (e.g., the system of FIG. 2) may be configured to process the instant message 304. The instant message system 302 may parse the instant message 304 to determine a proper noun. An index may be queried with the proper noun to determine a topic of interest that may be used to determine an endorsable entity. The instant message system 302 may present 306 the instant message and/or the endorsable entity associated with the topic of interest to the IM recipient.

FIG. 3B illustrates an example 350 of presenting an endorsable entity based upon a parsed instant message. In example 350, an IM sender may create an instant message 354 intended for delivery to an IM recipient. An instant message system 352 (e.g., the system of FIG. 2) may be configured to process the instant message 354. The instant message system 352 may parse the instant message 354 to determine a proper noun. An index may be queried with the proper noun to determine a topic of interest that may be used to determine an endorsable entity. The instant message system 352 may present 356 the instant message and/or the endorsable entity associated with the topic of interest to the IM recipient. The instant message system 352 may also present the endorsable entity associated with the topic of interest to the IM sender (e.g., in a conversation history log).

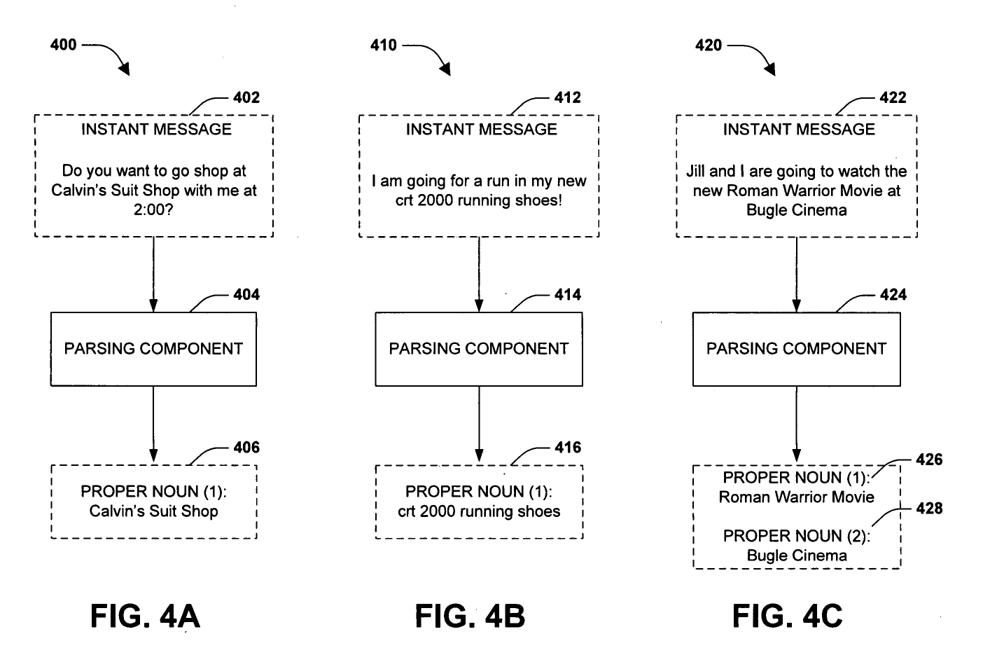

FIG. 4A illustrates an example 400 of parsing one or more proper nouns from an instant message. An instant message 402 may be parsed by a parsing component 404 for proper nouns. The parsing component 404 may determine “Calvin's Suit Shop” is a proper noun (e.g., a proper noun (1) 406 relating to a retail store).

FIG. 4B illustrates an example 410 of parsing one or more proper nouns from an instant message. An instant message 412 may be parsed by a parsing component 414 for proper nouns. The parsing component 414 may determine “CRT 2000 running shoes” is a proper noun (e.g., a proper noun (1) 416 relating to a model of a particular shoe).

FIG. 4C illustrates an example 420 of parsing one or more proper nouns from an instant message. An instant message 422 may be parsed by a parsing component 424 for proper nouns. The parsing component 424 may determine “Roman Warrior Movie” and “Bugle Cinema” are proper nouns. For example, a proper noun (1) 426 may relate to a particular movie and a proper noun (2) 428 may relate to a particular theatre.

It may be appreciated that a word or a grouping of words may be extracted from an IM as a proper noun, wherein the respective word or grouping of words may be used in determining whether they match a proper noun entry within an index.

FIG. 5 illustrates an example 500 of comparing a proper noun to an index to determine a topic of interest. A proper noun “CRT 2000” 502 may be parsed from an instant message as a proper noun. A lookup component 504 may be configured to compare the proper noun “CRT 2000” 502 to an index 506 to determine a topic of interest (e.g., a topic of interest “Tom's Shoe Store Advertisements” 512). The index 506 may comprise a list of proper nouns (e.g., one or more proper noun entries), wherein the list of proper nouns may comprise one or more variations of respective proper nouns.

In one example, the proper noun “CRT 2000” 502 may be received by the lookup component 504. The lookup component 504 may compare the proper noun “CRT 2000” 502 to the list of proper nouns within the index 506 to determine a matching proper noun entry (e.g., a proper noun entry 508). It may be determined that a topic of interest entry 510 corresponds to the proper noun entry 508. The topic of interest entry 510 may be extracted as the topic of interest “Tom's Shoe Store Advertisements” 512. It may be appreciated that the topic of interest “Tom's Shoe Store Advertisements” 512 may be utilized in determining an endorsable entity.

It may be appreciated that, although not illustrated in FIG. 5, the index 506 may comprise two or more proper nouns having a term in common, wherein the two or more proper nouns (e.g., proper noun entries within the index) may map to different topics of interest. For example, a first proper noun entry “CRT 2000” may correspond to a first topic of interest “Tom's Shoe Store Advertisements” and a second proper noun entry “2000” may correspond to a second topic of interest “2000 miles under the earth book club”. That is, if the proper noun “CRT 2000” is parsed from an instant message, then “2000” may also be extracted as a proper noun (e.g., a proper noun variation). In this situation, the same term “2000” would map to two different topics of interest. As a result, one or more endorsable entities (e.g., respectively corresponding to the different topics of interest) may be presented to an instant message user and/or the different topics of interest maybe pre-ordered or ranked in some manner so that a more desirable (e.g., higher ranked) topic of interest is presented to a user. It is to be appreciated that while the discussion herein generally describes a 1 to 1 mapping between a term and a topic of interest that the scope of this disclosure and the appended claims is not intended to be so limited. That is, other than such a 1 to 1 mapping is envisioned.

It may be appreciated that a word or a grouping of words may be extracted from an IM as a proper noun, wherein the respective word or grouping of words may be used in determining whether they match a proper noun entry within an index.

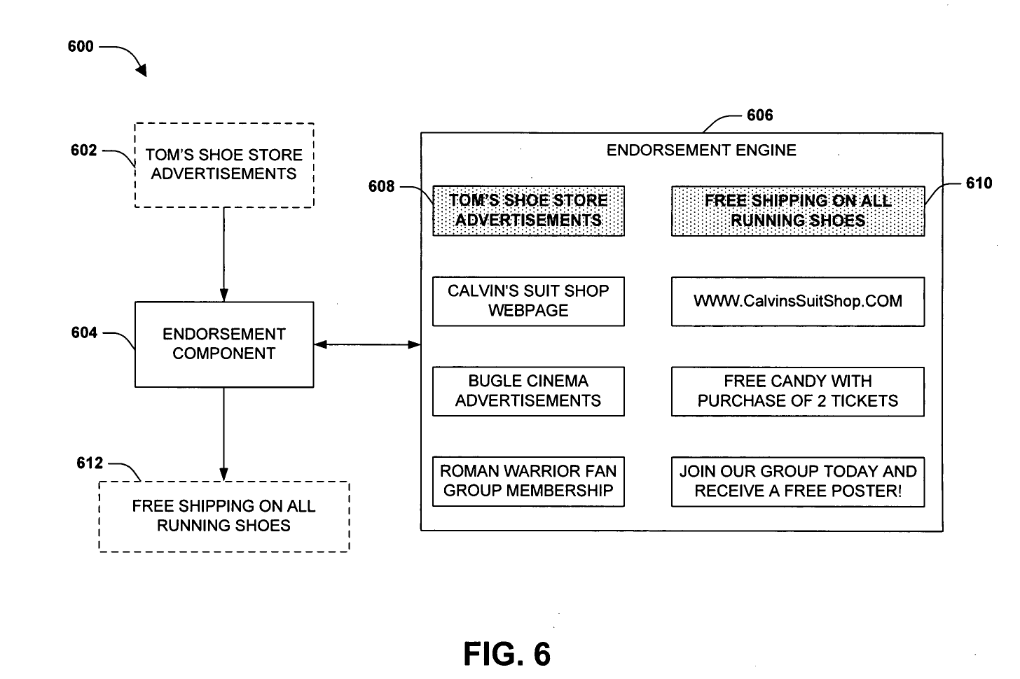

FIG. 6 illustrates an example 600 of determining an endorsable entity based upon a topic of interest. A topic of interest “Tom's Shoe Store Advertisements” 602 may be determined within an index based upon a parsed proper noun. An endorsement component 604 may be configured to query an endorsement engine 606 with the topic of interest “Tom's Shoe Store Advertisements” 602 to determine an endorsable entity (e.g., an endorsable entity “Free Shipping on All Running Shoes” 612). The endorsement engine 606 may comprise one or more endorsable entities corresponding to topics of interest. An endorsable entity may comprise an advertisement, a website, an image, a group request, etc.

In one example, the topic of interest “Tom's Shoe Store Advertisements” 602 may be received by the endorsement component 604. The endorsement component 604 may query the endorsement engine 606 with the topic of interest “Tom's Shoe Store Advertisements” 602 to determine a matching topic of interest (e.g., a topic of interest entry 608). It may be determined that an endorsable entity entry 610 corresponds to the topic of interest entry 608. The endorsable entity entry 608 may be extracted as the endorsable entity “Free Shipping on All Running Shoes” 612. It may be appreciated that the endorsable entity “Free Shipping on All Running Shoes” 612 may be appended to instant message metadata and/or presented to an instant message user.

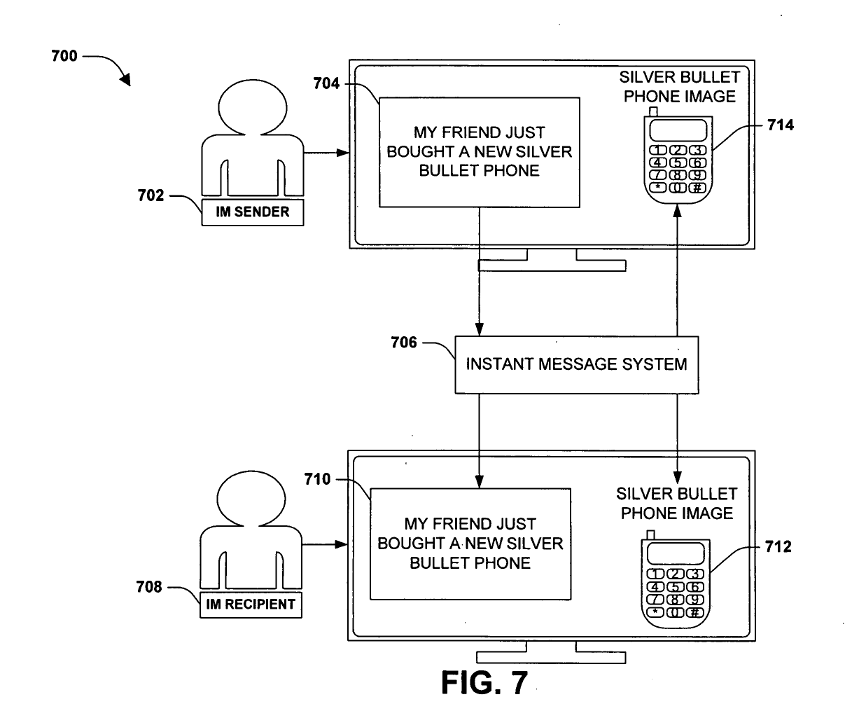

FIG. 7 illustrates an example 700 of presenting an endorsable entity based upon a parsed instant message. An instant message (IM) sender 702 may be engaged in an instant message session through an instant message service with an instant message (IM) recipient 708. The IM sender 702 may create a first instant message (IM) 704 (e.g., the IM sender 702 may write about a particular phone, a “Silver Bullet Phone”, a friend bought). The first IM 704 may be sent through the instant message service to the IM recipient 708. In one example, during processing of the first IM 704 by the instant message service, an instant message system 706 (e.g., the system of FIG. 2) may parse the first IM 704 for one or more proper nouns (e.g., a word, a grouping of words, etc.). For example, a proper noun “Silver Bullet Phone” may be extracted from the first IM 704.

The instant message system 706 may determine whether the proper noun “Silver Bullet Phone” parsed from the first IM 704 corresponds to proper noun entry within an index. It may be determined that the proper noun “Silver Bullet Phone” corresponds to a proper noun entry within the index, wherein the proper noun entry is associated with a topic of interest. The instant message system 706 may query an endorsement engine with the topic of interest to determine an endorsable entity (e.g., a Silver Bullet Phone Image). The Silver Bullet Phone Image may be appending to IM metadata of a second IM 710 (e.g., an IM corresponding to the first IM 704) which is to be presented to the IM recipient 708. The Silver Bullet Phone Image may be presented to the IM recipient 708 as a first endorsable entity 712. It may be appreciated that the Silver Bullet Phone Image may be presented to the IM sender 702 as a second endorsable entity 714.

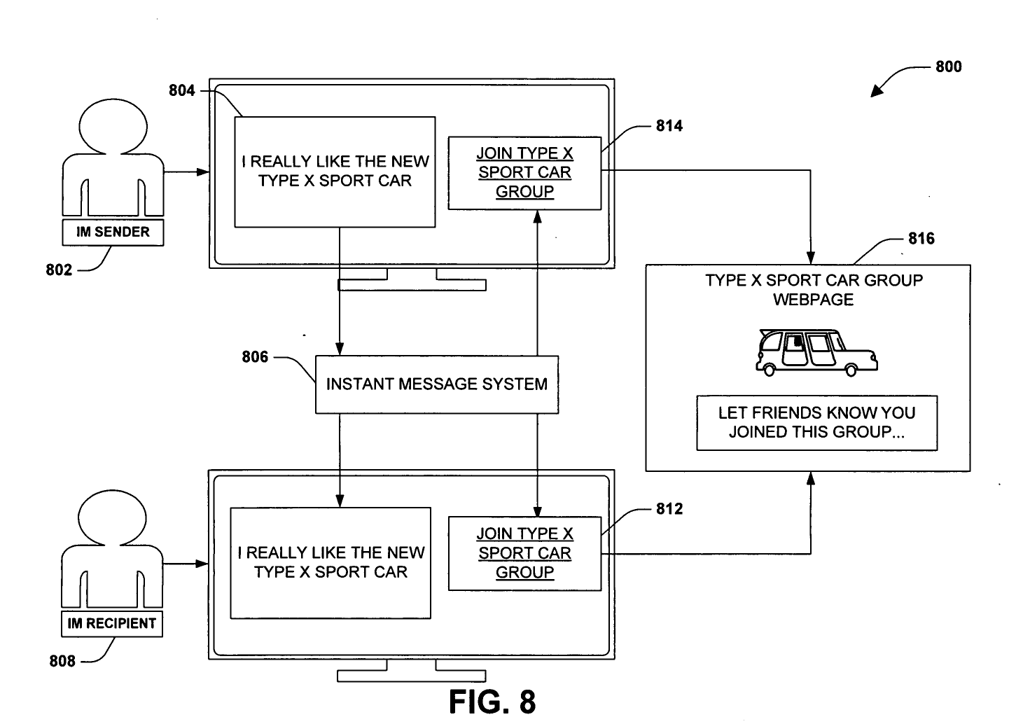

FIG. 8 illustrates an example 800 of presenting an endorsable entity based upon a parsed instant message. An instant message (IM) sender 802 may be engaged in an instant message session through an instant message service with an instant message (IM) recipient 808. The IM sender 802 may create a first instant message (IM) 804 (e.g., the IM sender 802 may write about the particular sports car “Type X Sport Car”). The first IM 804 may be sent through the instant message service to the IM recipient 808. In one example, during processing of the first IM 804 by the instant message service, an instant message system 806 (e.g., the system of FIG. 2) may parse the first IM 804 for proper nouns, determine a topic of interest corresponding to a parsed proper noun, and determine an endorsable entity based upon the topic of interest.

The instant message system 806 may parse the first IM 804 to determine a proper noun “Type X Sport Car”. The proper noun “Type X Sport Car” may be used in querying an index to determine a topic of interest corresponding to the proper noun “Type X Sport Car”. Based upon the topic of interest, an endorsable entity (e.g., a link to a Type X Sport Car group) may be determined. The endorsable entity may be presented to the IM recipient 808 as a first endorsable entity 812 and to the IM sender 802 as a second endorsable entity 814. The first and second endorsable entities may provide a hyperlink link to a web page 816, wherein the IM users (e.g., the IM sender 802, the IM recipient 808, etc.) may subscribe to a group corresponding to the “Type X Sport Car”. If one or more users subscribe to the group, then other users may be notified through a feed item within a social network that the subscribing user invoked the endorsable entity. This may promote other users with similar interests to also join the group.

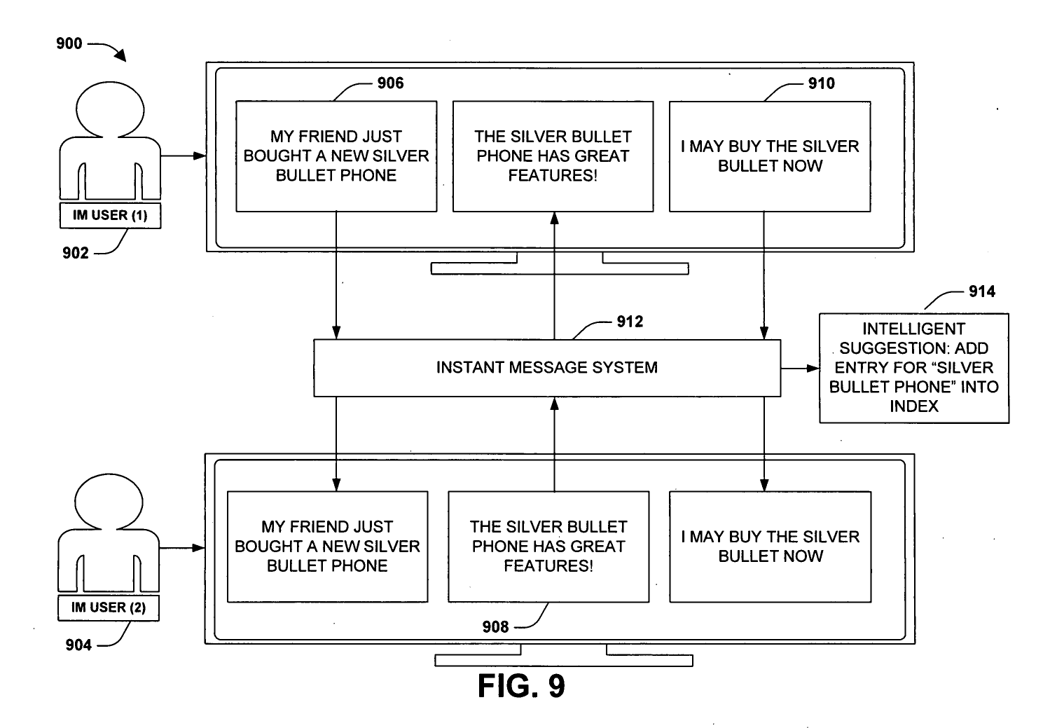

FIG. 9 illustrates an example 900 of creating an intelligent suggestion based upon an instant message session. A first IM user 902 and a second IM user 904 may be engaged in an instant message session (e.g., an instant message conversation comprising a first IM 906, a second IM 908, and a third IM 910). An instant message system 912 (e.g., the system of FIG. 2) may be configured to parse instant messages for proper nouns, which may be used to query an index to determine a topic of interest. It may be appreciated that a parsed proper noun may not exist within the index, thus no topic of interest may be determined.

In one example, the first IM user 902 may send the first IM 906 to the second IM user 904. The instant message system 912 may parse the first IM 906, wherein the parse detects a proper noun “Silver Bullet Phone”. The instant message system 912 may determine whether the proper noun “Silver Bullet Phone” matches an entry within an index. If there is no match, then nothing is done and the first instant message may be processed and/or delivered to the second IM user 904. Subsequent instant messages (e.g., the second IM 908 and the third IM 910) may be parsed by the instant message system 912. If the proper noun “Silver Bullet Phone” is parsed within multiple instant messages and does not match an entry within the index, then an intelligent suggestion 914 may be created (e.g., create the intelligent suggestion 914 when a frequency of unsuccessful matches exceeds a predetermined threshold). The intelligent suggestion may be created to provide notification that it may be advantageous for an entity (e.g., a company, a web site, etc.) associated with the proper noun to add the proper noun and/or a topic of interest and endorsable entity into the instant message system 912. In one example, the intelligent suggestion 914 may indicate that the proper noun “Silver Bullet Phone” should be added into the index. This may, for example, be presented in the form of a question such that a user may have to confirm this addition to the index.

It may be appreciated that an instant message user may be prompted to provide consent for instant messages to be parsed for the purpose of presenting endorsable entities. In one example, a user may be prompted with a dialog box explaining that data (e.g., proper nouns) may be parsed from instant message for the limited purpose of presenting endorsable entities, wherein the user may confirm or reject consent. In another example, an option within an instant message client may be available for an instant message user to enable parsing of instant messages for the limited purpose of presenting endorsable entities.

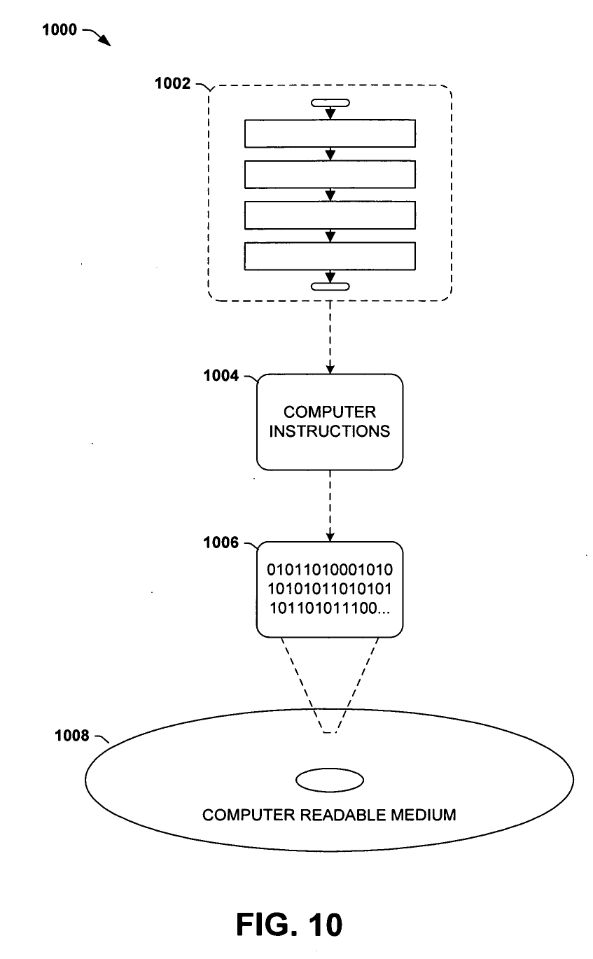

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1008 (e.g., a CD-R, DVD-R, or a platter of a hard disk drive), on which is encoded computer-readable data 1006. This computer-readable data 1006 in turn comprises a set of computer instructions 1004 configured to operate according to one or more of the principles set forth herein. In one such embodiment 1000, the set of computer instructions 1004 may be configured to perform a method 1002, such as the exemplary method 100 of FIG. 1, for example. In another such embodiment, the set of computer instructions 1004 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

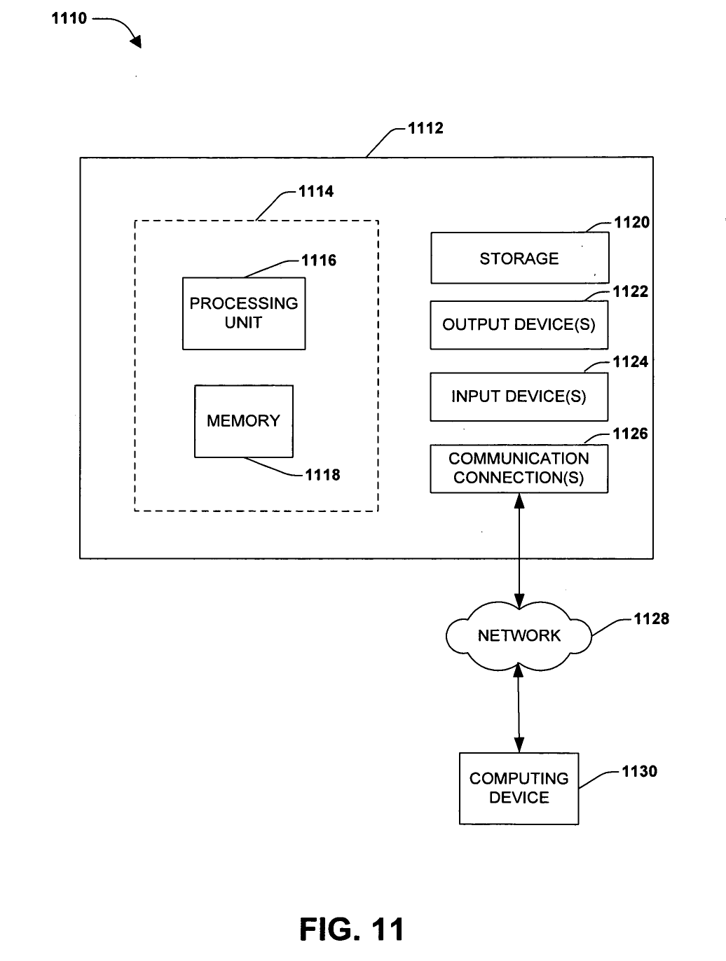

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such features may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for presenting an endorsable entity based upon a parsed instant message comprising:
parsing an instant message (IM) for a proper noun;
comparing the proper noun to an index to determine a topic of interest; and
presenting an endorsable entity to an IM user based upon the topic of interest.

2. The method of claim 1, the comparing comprising determining if a variation of the proper noun is present in the index.

3. The method of claim 2, the variation comprising at least one of:
an expansion of the proper noun;
a contraction of the proper noun; and
an acronym of the proper noun.

4. The method of claim 1, the parsing comprising monitoring real-time data of an IM session between one or more users.

5. The method of claim 1, the endorsable entity comprising at least one of:
an advertisement corresponding to the topic of interest;
a hyperlink linking to a web page corresponding to the topic of interest;
a user interface (UI) element corresponding to the topic of interest; and
a subscription request corresponding to the topic of interest.

6. The method of claim 1, comprising:
creating a feed item within a social network based upon a user invoking the endorsable entity.

7. The method of claim 1, comprising:
creating an intelligent suggestion based upon a proper noun parsed at a frequency exceeding a predetermined threshold, wherein the proper noun is not within the index.

8. The method of claim 1, comprising:
determining the endorsable entity based upon querying an endorsement engine with the topic of interest.

9. The method of claim 1, the presenting comprising:
encoding the endorsable entity within IM metadata associated with the IM;
delivering the IM and the IM metadata to an IM recipient; and
presenting the endorsable entity to the IM recipient.

10. The method of claim 1, the presenting comprising:
encoding the endorsable entity within IM metadata;
sending the IM metadata to an IM sender; and
presenting the endorsable entity to the IM sender.

11. A system for presenting an endorsable entity based upon a parsed instant message comprising:
a parsing component configured to parse an instant message (IM) for a proper noun;
a lookup component configured to compare the proper noun to an index to determine a topic of interest; and
a presentation component configured to present an endorsable entity to an UI user based upon the topic of interest.

12. The system of claim 11, comprising:
an endorsement component configured to determine the endorsable entity by querying an endorsement engine with the topic of interest.

13. The system of claim 11, the parsing component configured to monitor real-time data of an IM session between one or more users.

14. The system of claim 11, the endorsable entity comprising at least one:
an advertisement corresponding to the topic of interest;
a hyperlink linking to a web page corresponding to the topic of interest;
a user interface (UI) element corresponding to the topic of interest; and
a subscription request corresponding to the topic of interest.

15. The system of claim 11, the presentation component configured to create a feed item within a social network based upon a user invoking the endorsable entity.

16. The system of claim 11, the lookup component configured to create an intelligent suggestion based upon a proper noun parsed at a frequency exceeding a predetermined threshold, wherein the proper noun is not within the index.

17. The system of claim 11, the lookup component configured to determine if a variation of the proper noun is present in the index.

18. The system of claim 11, the presentation component configured to:
encode the endorsable entity within IM metadata associated with the IM;
deliver the IM and the IM metadata to an IM recipient; and
present the endorsable entity to the IM recipient.

19. The system of claim 11, the presentation component configured to:
encode the endorsable entity within IM metadata;
deliver the IM metadata to an IM sender; and
present the endorsable entity to the IM sender as a hyperlink within a conversation history.

20. A method for presenting an endorsable entity based upon a parsed instant message comprising:
receiving an instant message (IM) from a IM sender;
parsing the instant message (IM) for a proper noun;
comparing the proper noun to an index to determine a topic of interest;
determining an endorsable entity based upon the topic of interest;
encoding the endorsable entity within a first IM metadata and a second IM metadata;
sending the first IM metadata to the IM sender and the second IM metadata to an IM recipient; and
presenting the endorsable entity within the first IM metadata to the IM sender and the endorsable entity within the second IM metadata to the IM recipient.
